(19) United States
(12) Patent Application Publication
(10) Pub. No.: US 2007/0217215 A1
(43) Pub. Date: Sep. 20, 2007

(54) Lamp shield driving apparatus providing multiple beam patterns and lamp assembly using the same

(75) Inventor: Tae-Won Lee, Gyeongsangbuk-do (KR)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(73) Assignee: SL Corporation, Daego (KR)

(21) Appl. No.: 11/699,952

(22) Filed: Jan. 30, 2007

(30) Foreign Application Priority Data
Mar. 17, 2006 (KR) 10-2006-0024871

(51) Int. Cl. B60Q 1/00

(52) U.S. Cl. 362/539

(57) ABSTRACT

Disclosed is a lamp assembly providing multiple beam patterns in accordance with traveling conditions of a vehicle. The lamp assembly includes a lamp, a lamp shield driving apparatus blocking a part of light from the lamp by a predetermined shield pattern, a lens condensing the blocked light forward, and a housing accommodating the lamp and the lamp shield driving apparatus. The lamp shield driving apparatus includes a first shield having a predetermined cut off pattern, a second shield overlapping with the first shield and having a different cut off pattern from the first shield, and a driving unit moving either the first shield or the second shield linearly. Two or more beam patterns are formed in accordance with the movement of any one of the shields while the first shield overlaps with the second shield.

### CROSS REFERENCE TO RELATED APPLICATION

This application claims priority from Korean Patent Application No. 10-2006-24871 filed on Mar. 17, 2006 in the Korean Intellectual Property Office, the disclosure of which is incorporated herein by reference in its entirety.

### BACKGROUND OF THE INVENTION

1. Field of the Invention

The present invention relates to a head lamp, and more particularly, to a lamp assembly that provides multiple beam patterns in accordance with traveling conditions of a vehicle.

2. Description of the Related Art

A head lamp, which is also called a headlight, is a lamp illuminating a forward path of a vehicle, which requires luminous intensity such that obstacles located 100 m ahead of the road can be recognized. Each country has different standards of the head lamp from each other. In particular, the head lamp beam has a different irradiation direction according to whether traffic keeps to the right or to the left.

In general, the head lamp is designed such that the beam of a vehicle of an LHD (Left Hand Drive) is irradiated further to the right side of the traveling direction of the vehicle, with respect to the center line of the road, the beam of a vehicle of RHD (Right Hand Drive) is irradiated further to the left side. That is, regardless of whether the left hand drive or right hand drive, the beam of the head lamp is irradiated weaker to the closer side to the center line. By controlling the irradiation direction of the beam of the head lamp, the amount of beam to be irradiated on drivers who are driving in the opposite direction is decreased so as to prevent glare on the eyes of the drivers to keep the regulation.

A vehicle head lamp in the related art provides a driver with a fixed illumination pattern regardless of the various conditions of the road. Therefore, a driver cannot have an appropriate view for a safe driving, during high speed driving when a longer distance view should be ensured, and during driving in the downtown area where dependency on the intensity of light of the head lamp decreases due to the surrounding illumination being relatively bright, during driving in the heavy rain where glare on the opposite side increases due to reflected light from rain, snow or a wet road and the view becomes narrow.

Therefore, an object of the invention is to provide an illumination pattern that is optimized for changes in road conditions, as compared to the fixed illumination pattern in the related art, which ensures safe driving even with different road conditions.

### SUMMARY OF THE INVENTION

An object of the present invention is to optimize an illumination pattern in accordance with a road condition that continuously changes during traveling, which provides a driver with an appropriate view for the road condition.

Objects of the present invention are not limited to those mentioned above, and other objects of the present invention will be apparently understood by those skilled in the art through the following description.

According to an aspect of the present invention, there is provided a lamp shield driving apparatus including a first shield having a predetermined cut off pattern, a second shield overlapping with the first shield and having a different cut off pattern from the first shield, and a driving unit moving either the first shield or the second shield linearly. In this case, two or more beam patterns are formed in accordance with the movement of any one of the shields while the first shield overlaps with the second shield.

According to another aspect of the present invention, there is provided a lamp assembly including a lamp, a lamp shield driving apparatus blocking a part of light from the lamp by a predetermined shield pattern, a lens condensing the blocked light forward, and a housing accommodating the lamp and the lamp shield driving apparatus. The lamp shield driving apparatus includes a first shield having a predetermined cut off pattern, a second shield overlapping with the first shield and having a different cut off pattern from the first shield, and a driving unit moving either the first shield or the second shield linearly. Two or more beam patterns are formed in accordance with the movement of any one of the shields while the first shield overlaps with the second shield.

Details of other embodiments of the present invention are included in the detailed description and drawings.

### BRIEF DESCRIPTION OF THE DRAWINGS

The above and other features and advantages of the present invention will become more apparent by describing in detail preferred embodiments thereof with reference to the attached drawings, in which:

FIG. 1 is a view schematically showing a construction of a projection type head lamp.

FIG. 2A is a view showing a beam irradiation pattern according to class C.

FIG. 2B is a view showing a beam irradiation pattern according to class V.

FIG. 2C is a view showing a beam irradiation pattern according to class E.

FIG. 2D is a view showing a beam irradiation pattern according to class W.

FIG. 3A is a view showing class C according to an embodiment of the invention.

FIG. 3B is a view showing class E according to the embodiment of the invention.

FIG. 3C is a view showing a high lamp pattern according to the embodiment of the invention.

FIG. 3D is a view showing class V according to the embodiment of the invention.

FIG. 4 is an exploded perspective view of a construction of a lamp shield driving apparatus according to the embodiment of the invention.

FIG. 5 is a perspective view illustrating a lamp shield driving apparatus in a class C state of FIG. 3A.

FIG. 6 is a perspective view illustrating the lamp shield driving apparatus of FIG. 5, as seen from the rear side.

FIG. 7 is a perspective view illustrating the lamp shield driving apparatus in a class E state of FIG. 3B.

FIG. 8 is a perspective view illustrating the lamp shield driving apparatus in a high lamp state of FIG. 3c.

FIG. 9 is a perspective view illustrating a lamp shield driving apparatus in a class V state of FIG. 3D.

FIG. 10 is a view showing the case when the lamp shield driving apparatus is assembled into a lamp assembly.

FIG. 11 is a view showing the case when a lens is assembled into the lamp assembly of FIG. 10.

FIG. 12 is a perspective view of the lamp assembly of FIG. 11, as seen from the rear side.

### DESCRIPTION OF THE PREFERRED EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

An embodiment of the invention will be described in detail with reference to the accompanying drawings.

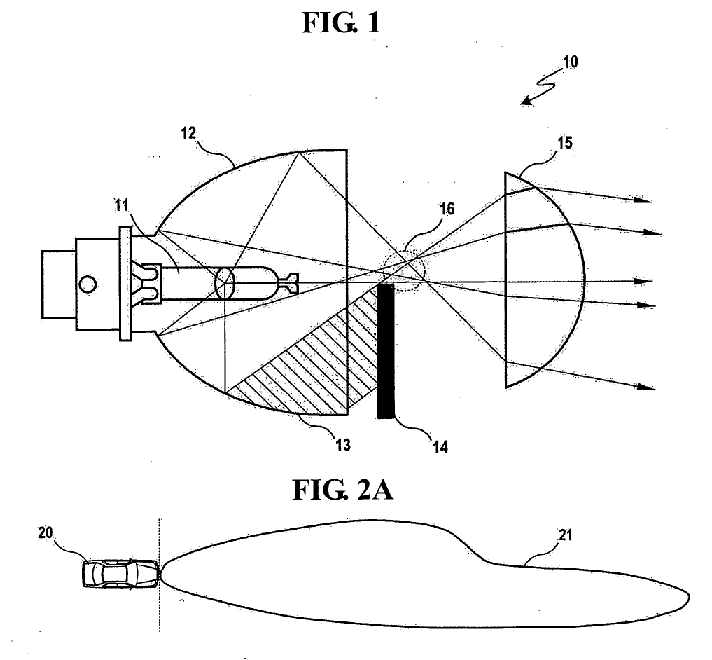

FIG. 1 is a view schematically showing a construction of a projection type head lamp 10. The projection type head lamp converges light, which is more advantageous to a light distribution surface, as compared to a typical clear type, and makes the front side of the vehicle to have a sporty look.

A light-emitting lamp 11 emits light, and the light is reflected by a mirror surface 12 formed with a predetermined shape (for example, oval) and converges to a place 16 in front of the lamp 11. The converged light is refracted by a refractive lens 15 provided in front of the light so as to be irradiated in the forward direction. A light component that is emitted upward among the emitted light is reflected by the mirror surface 12 and travels downward, and a light component that is emitted downward is reflected by a mirror surface 13 and travels upward. Except for the case when a high beam is irradiated, the light that is emitted downward and travels upward is blocked by a shield 14, which prevents inconvenience to drivers.

As described above, the projection type head lamp 10 is different from the clear type head lamp in that the light reflected by the mirror surface 12 converges substantially to the place 16. Therefore, even when the shape of the shield 14 in the vicinity of the place 16 is slightly changed, it is possible to form multiple beam irradiation patterns.

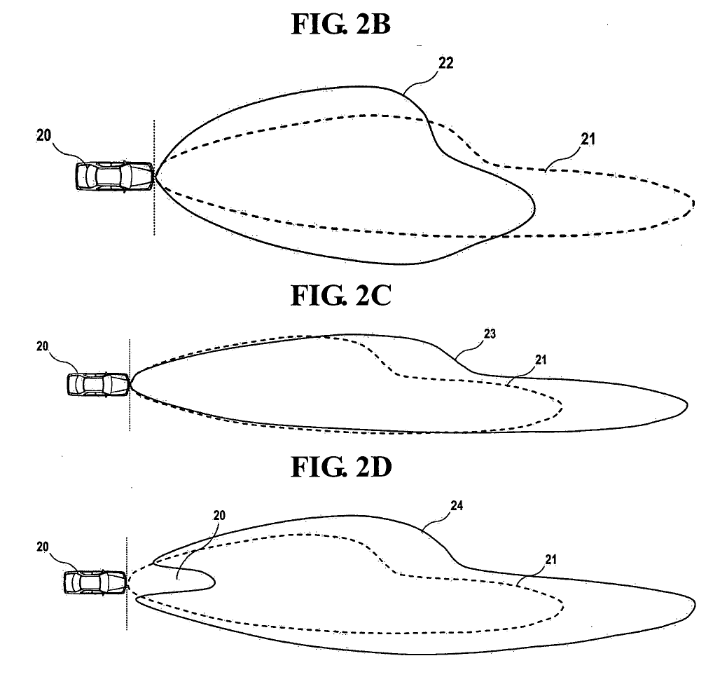

FIGS. 2A to 2D are views showing multiple beam irradiation patterns. FIG. 2A shows class C. Class C is a beam pattern 21 that is appropriate when a vehicle 20 travels on a country road. When compared to a typical low beam, class C is obtained by increasing the amount of light without causing inconvenience to a view of the road on the opposite side.

FIG. 2B shows class V. Class V is a beam pattern appropriate when the vehicle 20 travels in such an environment that ensures enough light intensity such as a downtown area. In particular, a left/right view increases as compared to that of class C 21, a view of a shorter length (50 to 60 m ahead of a vehicle) than class C 21 is ensured. In this case, to increase the left/right view, generally, the irradiation direction of the head lamp on the left/right side is slightly tilted outward.

FIG. 2C shows class E. Class E is a beam pattern appropriate when the vehicle 20 travels on a highway or a straight road. Therefore, class E 23 has a slightly longer forward long distance view than class C 21.

Last, FIG. 2D shows class W. Class W is a beam pattern appropriate when the vehicle 20 travels in the rain, or on a wet road. Therefore, the forward long distance view of class W is similar to that of class E 23, but the amount of light is decreased up to 10 to 20 m ahead of a vehicle to reduce reflective glare.

As shown in FIGS. 2A to 2D, it is necessary to change the beam pattern in the actual vehicle 20 in accordance with various traveling conditions. In particular, in the case of using the projection type head lamp, it is possible to change multiple beam patterns by only changing a shield. However, as for a method of changing the beam pattern in the related art, the construction is complex and manufacturing cost is high, and problems are found in that it is difficult to accurately control a shield pattern for forming a specific beam pattern.

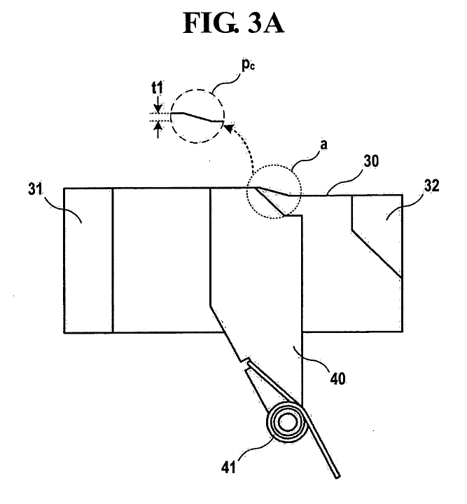

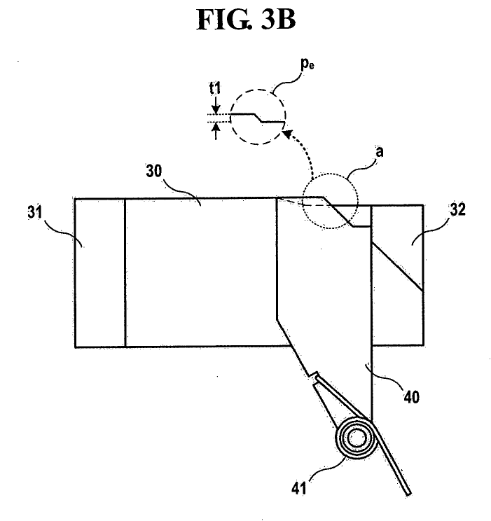

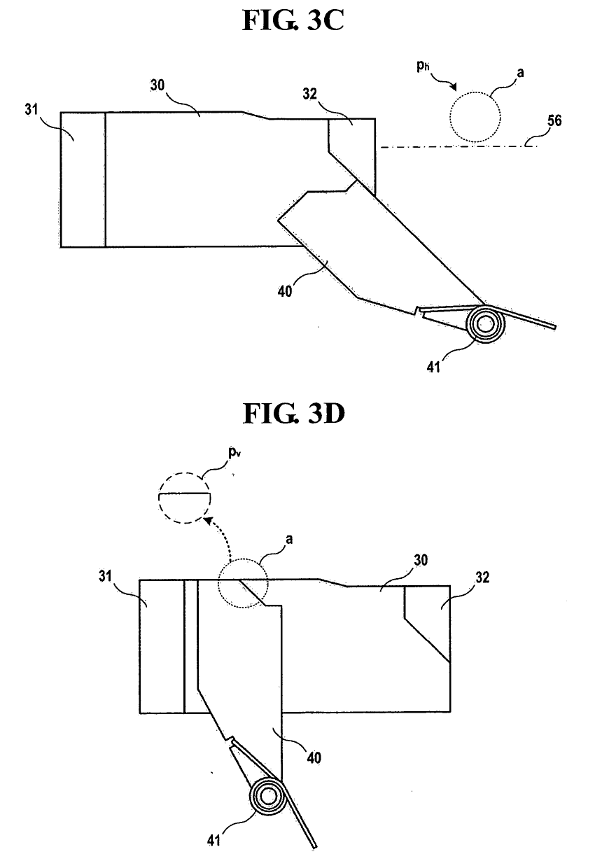

For this, according to the invention, there is provided a method of simply forming multiple beam patterns (class C, class E, class V, and high lamp) by overlapping a class C shield (first shield) with a class E shield (second shield), and moving one of these shields in a horizontal direction. FIG. 3A to 3D are views respectively showing a combination of a first shield 30 and a second shield 40, forming class C, class E, class V, and a high lamp.

First, as shown in FIG. 3A, the case where the first shield 30 overlaps with the second shield 40 indicates class C. The class C is formed by a cut off pattern of the first shield 30, and the second shield 40 does not directly involve in forming the pattern. If the place “a” is where the light of the projection lamp converges, a shield pattern p_{c} of class C is composed of two horizontal lines (upper line and lower line) and a line which connects the two lines and is inclined downward to the right at a predetermined first angle. A step having a predetermined size t1 exists between the two horizontal lines.

The first shield 30 includes a first engaging protrusion 31 in the horizontal direction on the left side, and a second engaging protrusion 32 in a diagonal direction on the right side. The second shield 40 is supported by a torsion spring 41 so as to keep its vertical position, as shown in FIG. 3A, while an external force is removed. In class C state (neutral state), as shown in FIG. 3A, if the first shield 30 moves to the left or right by a predetermined offset, another beam pattern can be formed.

FIG. 3B shows class E that is formed by moving the first shield 30 of FIG. 3A moves to the left. The class E is formed by a cut off pattern of the second shield 40, and the first shield 30 also involves in forming the pattern. As for a shield pattern pₑ of class E that is formed in the place “a” where the light of the projection lamp converges, the shield pattern p_{c} of class E is composed of two horizontal lines (upper line and lower line) and a long which connects the two lines and is inclined downward to the right at a predetermined second angle. The first shield 30 involves in forming one of the two horizontal lines. While a step having the same size t1 as the size of class C exists between the two horizontal lines, the second angle is larger than the first angle of class C.

In the case of FIG. 3B, if the first shield 30 moves further to the left, the second shield 40 is brought into contact with the second engaging protrusion 32 of the first shield and tilts about a rotational axis to which the torsion spring 41 is connected (see FIG. 3C). If so, no shield is applied to the place “a” where the light of the projection lamp converges, the light that is emitted downward and reflected upward in FIG. 1 can pass. That is, a high lamp pattern is formed. Even if an additional fixed shield is added to the first shield 30 and the second shield 40, a horizontal level 56 of the fixed shield is positioned low so as not to deter the light that is reflected upward. Afterwards, when the first shield 30 returns to the initial position, the second shield 40 returns to the initial vertical position by resilience of the torsion spring 41.

In the meantime, in the case of FIG. 3A, if the first shield 30 moves to the right by more than a predetermined size, more than a lower half of the place “a” where the light of the projection lamp converges is covered by the horizontal portion of the first shield 30 (upper horizontal portion of the two horizontal portions) (see FIG. 3D). Therefore, class V is formed to have a shorter beam irradiation distance than class C or class E. However, the irradiation direction of the right and left head lamps needs to be further tilted to the outside to form a broader view angle in a transverse direction of the vehicle 20. A technique of horizontally tilting the head lamp is disclosed in many related arts, thus, description thereof will be omitted in this specification.

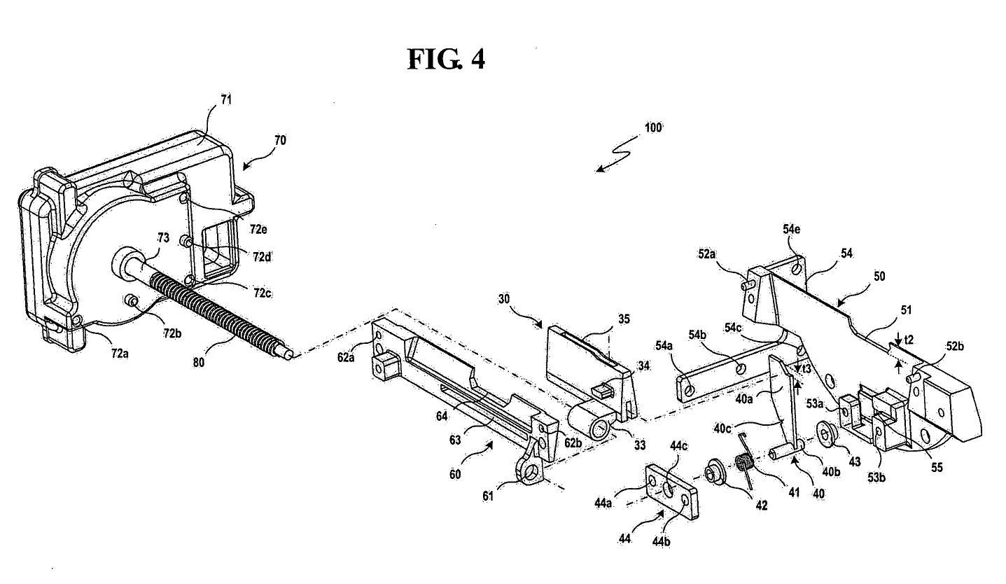

FIG. 4 is an exploded perspective view of a construction of a lamp shield driving apparatus 100 according to the embodiment of the invention. The lamp shield driving apparatus 100 includes the first shield 30, the second shield 40, a fixed shield 50, a fixed shield cover 60, a step motor 70, and a lead screw 80. A driving unit is defined by the step motor 70 and the lead screw 80.

The fixed shield 50 is a stationary shield, which is formed in a semicircular shape so as to cover a lower half surface from the light provided by the projection lamp. A bracket 54 is provided to one side of the fixed shield 50, such that the fixed shield 50 is joined with a step motor housing 71. The fixed shield 50 is fixed by fastening screw holes 54a to 54e formed through the bracket 54 and screw holes 72a, 72c, and 72e and protrusions 72b and 72d formed at one surface of the step motor housing 71.

A notch 51 is formed at the center of the linear part of the semicircular fixed shield 50 so as to a have a step with size t2 from the linear part, such that converged light from the projection lamp can pass through the notch. In addition, a circular hole 55 is formed at the lower end part of the fixed shield 50, such that the rotation shaft 40b of the second shield 40 is inserted through the hole.

The first shield 30 has a sectional shape shown in FIGS. 3A to 3D. That is, the cut off pattern of the upper end, which substantially functions as a shield, is composed of two lines (upper line and lower line) having a step with a predetermined size t1 therebetween and a slant line connecting the two lines. A slider 34 protrudes at a portion of the surface of the first shield 30 so as to guide the first shield 30 to move horizontally, and a female screw 33 is formed at the lower end part of the first shield 30 so as to be joined with the lead screw 80 to allow linear movement. If the lead screw 80 rotates in one direction, the first shield 30 linearly moves in the transverse direction by the male screw-female screw joint relationship.

A vertical through hole 35 is formed through the first shield 30, as seen from above. With respect to the vertical through hole 35, a vertical first engaging protrusion 31 is formed at the left, and a diagonal second engaging protrusion 32 is formed at the right, as described above with reference to FIGS. 3A to 3D. A shield plate 40a of the second shield 40 is inserted through the vertical through hole 35, thereby forming an overlapped shape shown in FIGS. 3A to 3D.

The second shield 40 includes the shield plate 40a, the rotation shaft 40b which allows the shield plate 40a to rotate, a fixing hole 40c which is formed at one side of the shield plate 40a and fixes one end of the torsion spring 41. One end of the rotation shaft 40b passes through a bearing 43 so as to be inserted into the circular hole 55 of the fixed shield 50, and the other end of the rotation shaft 40b passes through the torsion spring 41 and the bearing 42 so as to be inserted into a circular hole 44c of a fixing block 44. As the fixing block 44 has two screw holes 44a and 44b, and they are joined with screw holes 53a and 54b of the fixed shield 50 by screwing, the second shield 40 is restricted from moving other than rotating about the rotation shaft 40b.

The cut off pattern at the upper end of the shield plate 40a is composed of two lines (upper line and lower line) having a step with a predetermined size t3 and a slant line connecting the two lines. The size t3 is larger than the size t1 that is the step of the first shield 30, and the inclination of the slant line is larger than that of the slant line of the first shield 30.

The fixed shield cover 60 is fastened to the fixed shield 50 so as to form a space to accommodate the first shield 30. For this, screw holes 62a and 62b of the fixed shield cover 60 are joined with protrusions 52a and 52b of the fixed shield 50. A notch 64 of a predetermined size t2 is formed at the upper end part of the fixed shield cover 60. Preferably, the notch 64 is formed in a similar shape to that of the notch 51.

In addition, a long slot 63 is formed in the fixed shield cover 60 in the horizontal direction, the slider 34 of the first shield 30 is inserted in the slot 63, and the slider 34 guides the first shield 30 to linearly move along the slot 63. Additionally, a circular ring 61 is formed at one side of the fixed shield cover 60, such that an end of the lead screw 80 is inserted into the ring 61, thus preventing the lead screw 80 from bending.

The step motor 70 rotates the lead screw 80 that is directly connected to a driving shaft 73 in an axial direction at a desired angle. Since the lead screw 80 is combined with the female screw 33 of the first shield 30, relationship between a rotational angle and a horizontal displacement of the first shield 30 is defined, according to pitches of the lead screw. Accordingly, it is understood how far the driving shaft 73 should be rotated to gain a specific horizontal displacement of the first shield 30.

In general, a step motor has more advantages than the other AC servo motor and DC servo motor in respect to controlling angles accurately. The step motor is a device to convert digital pulses into mechanical axial movement, and a distal source applies pulses. The shaft of the motor rotates at a predetermined angle per pulse. Taking this into consideration, it is possible to control a method of driving and the speed, by setting an interval between pulses properly. However, other driving devices, such as a servo motor and a linear motor (in this case, it is unnecessary to convert rotation into linear movement, and vice versa, by the male screw-female screw relationship), may be used instead of the step motor.

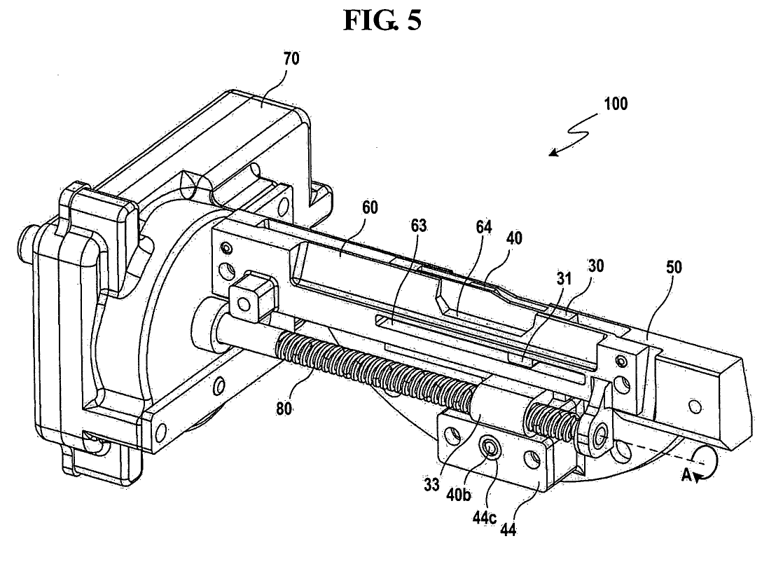

FIG. 5 is a view showing the assembly of the components of FIG. 4. FIG. 5 is a perspective view showing the lamp shield driving apparatus 100 in class C state of FIG. 3A. The first shield 30 is inserted into a space formed by the fixed shield 50 and the fixed shield cover 60, and the second shield 40 is inserted into the vertical through hole of the first shield 30. As for the second shield 40, in the class C state, the notch 64 is hidden by the first shield 30, and the second shield 40 is not actually involved in forming the beam pattern.

The slider 34 of the first shield 30 is inserted into the slot 63 of the fixed shield cover 60, the rotation shaft 40b of the second shield 40 is inserted into the circular hole 44c of the fixing block 44, and the lead screw 80 is joined with the female screw 33 of the first shield 30.

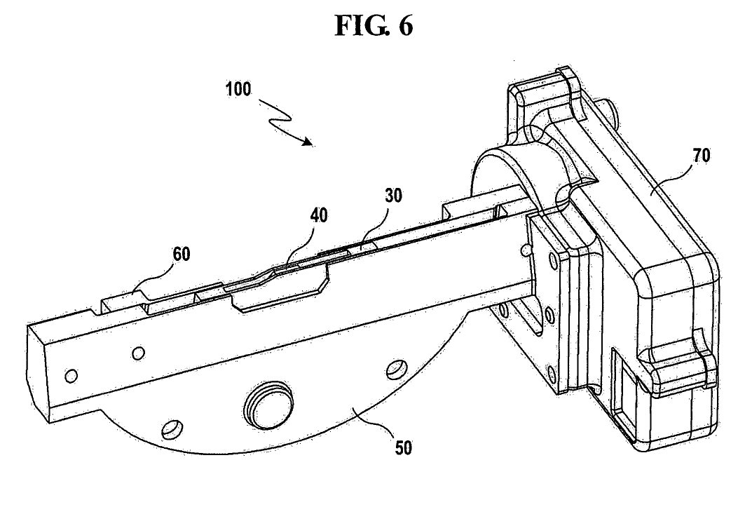

FIG. 6 is a perspective view showing the lamp shield driving apparatus 100 of FIG. 5, as seen from the rear side. The lamp is located ahead of the fixed shield 50 of FIG. 6. The entire surface of the fixed shield 50 and the first shield 30 block the light of the lamp.

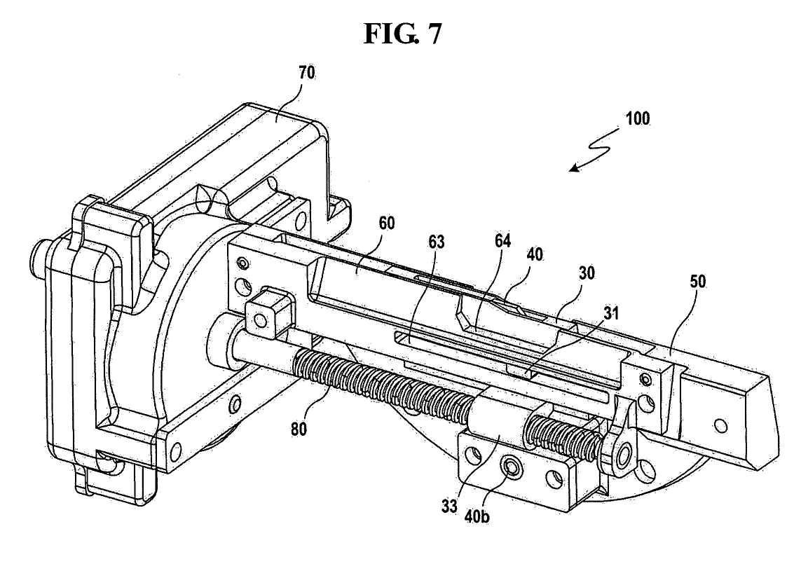

FIG. 7 is a perspective view showing the lamp shield driving apparatus 100 in class E state of FIG. 3B. In class C state of FIG. 5, if the lead screw 80 is rotated in direction A, the first shield 30 moves toward the step motor 70, accordingly, the upper end of the second shield 40 is exposed as shown in FIG. 7, thus obtaining class E of FIG. 3B.

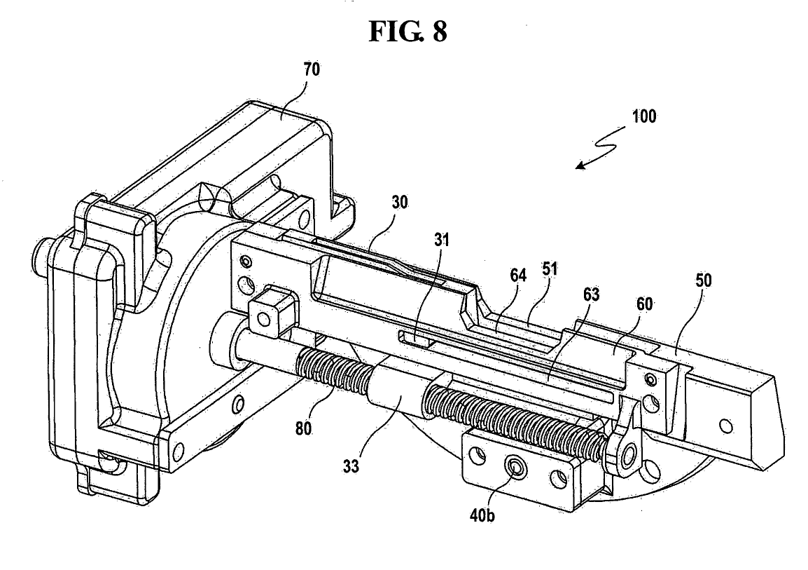

FIG. 8 is a perspective view showing the lamp shield driving apparatus 100 in a high lamp state of FIG. 3C. In class E state of FIG. 7, if the lead screw 80 is further rotated in direction A, the first shield 30 moves further toward the step motor 70, thus exposing the notch 51 of the fixed shield 50 and the notch 64 of the fixed shield cover 60. Like FIG. 3C, as the first shield 30 moves, the second shield is brought into contact with the second engaging protrusion 32 of the first shield 30 and tilted with respect to the rotation shaft 40b, thus not hiding the notches 51 and 64.

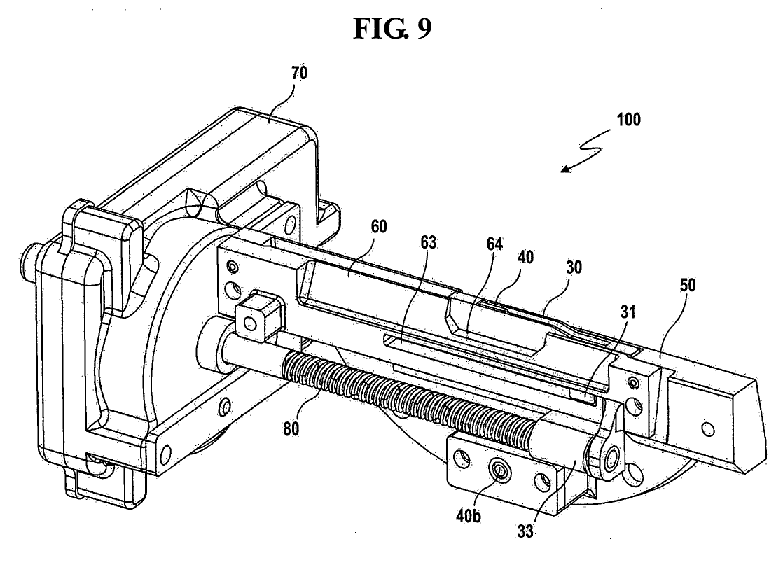

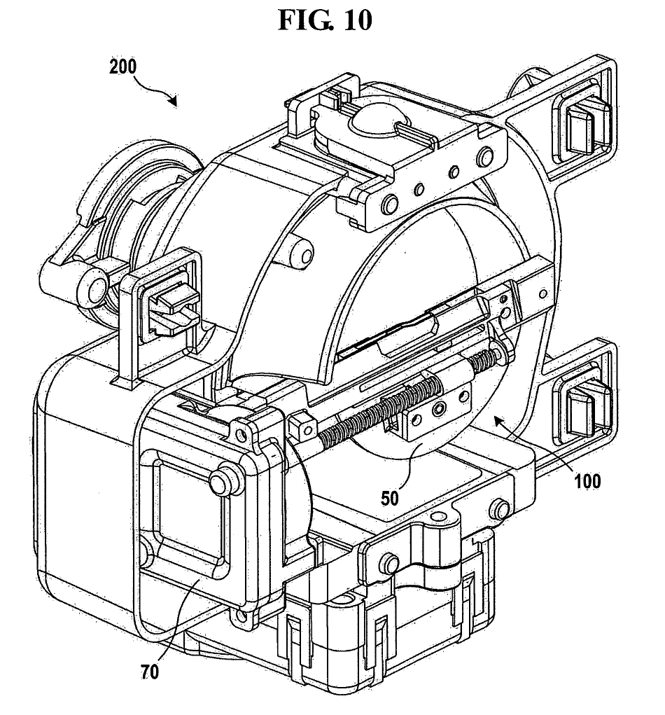

FIG. 9 is a perspective view showing the lamp shield driving apparatus 100 in class V state of FIG. 3D. In the class C state of FIG. 5, if the lead screw 80 is rotated in the reverse direction to direction A, the first shield 30 moves away from the step motor 70, thus hiding the notches 51 and 64 by the upper line of the first shield 30, and obtaining class E state of FIG. 3D.

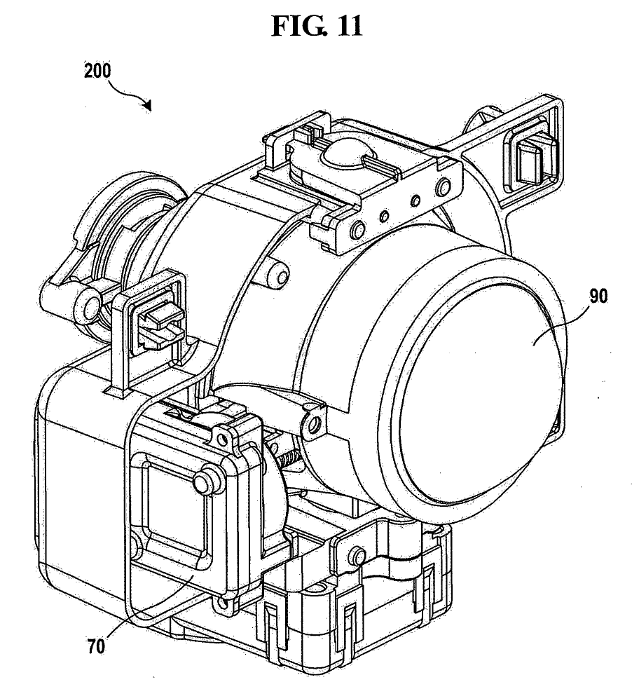

FIG. 10 is a view showing the case when the lamp shield driving apparatus 100 is assembled into a lamp assembly 200. In the lamp shield driving apparatus 100, the step motor 70 may be disposed at the left end or right end of the fixed shield 50.

FIG. 11 is a view showing the case when a lens 90 is assembled into the lamp assembly 200 of FIG. 10. The lens 90 is a refractive lens to be disposed to the front surface of the lamp assembly 200 of FIG. 10, and is used to increase the intensity of the light emitted from the lamp.

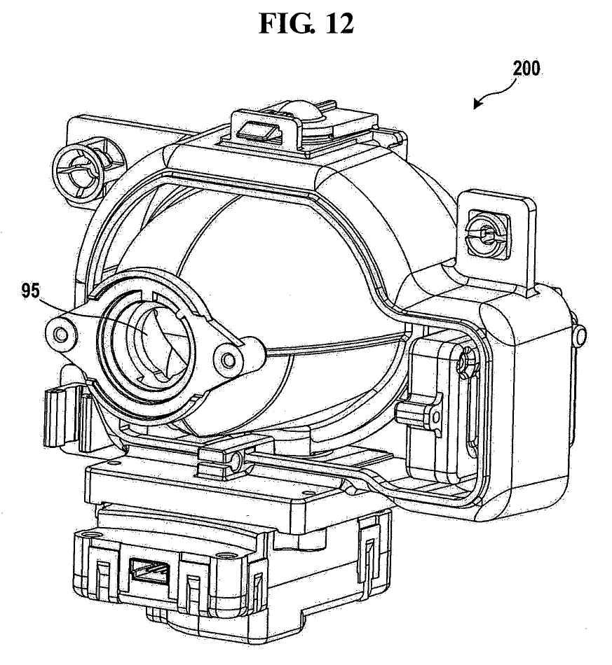

FIG. 12 is a perspective view of the lamp assembly 200 of FIG. 11, as seen from the rear side. A lamp hole 95 is formed at the rear side of the lamp assembly 200, such that the projection lamp is inserted into the lamp hole. When the lamp is disposed in the lamp hole 95, the assembling of the lamp assembly 200 is completed.

Although the present invention has been described in connection with the exemplary embodiments of the present invention, it will be apparent to those skilled in the art that various modifications and changes may be made thereto without departing from the scope and spirit of the invention. Therefore, it should be understood that the above embodiments are not limitative, but illustrative in all aspects.

According to the invention, as described above, it is possible to change the beam patterns of the head lamp in accordance with various traveling conditions, while ensuring a view of a driver appropriate for various road conditions, thus improving driving safety.

What is claimed is:

1. A lamp assembly comprising:
a lamp;
a lamp shield driving apparatus blocking a part of light from the lamp by a predetermined shield pattern;
a lens condensing the blocked light forward; and
a housing accommodating the lamp and the lamp shield driving apparatus,
wherein the lamp shield driving apparatus comprises:
a first shield having a predetermined cut off pattern;
a second shield overlapping with the first shield, and having a different cut off pattern from the first shield;
a driving unit moving either the first shield or the second shield linearly, and
two or more beam patterns are formed in accordance with the movement of any one of the shields while the first shield overlaps with the second shield.

2. The lamp assembly of claim 1, further comprising:
a fixed shield including a notch having a step with a predetermined size, the fixed shield having a substantially semicircular shape; and
a fixed shield cover fastened to the fixed shield to form a space for accommodating the first shield.

3. The lamp assembly of claim 2, wherein:
the first shield linearly moves by the driving unit; and
the second shield is tilted with respect to a predetermined rotation axis.

4. The lamp assembly of claim 3, wherein the cut off pattern is composed of two horizontal lines having a predetermined step therebetween and a slant line connecting the two horizontal lines.

5. The lamp assembly of claim 4, wherein the second shield has a larger step than the first shield.

6. The lamp assembly of claim 4, wherein the slant line of the second shield is more steeply inclined than the slant line of the first shield.

7. The lamp assembly of claim 3, wherein:
the driving unit comprises a step motor rotating a driving shaft at a specific angle and a lead screw directly connected to the driving shaft in an axial direction; and
the first shield linearly move by rotating the lead screw.

8. The lamp assembly of claim 7, wherein the second shield is brought into contact with an engaging protrusion of the first shield due to the linear movement of the first shield, so that the second shield is tilted.

9. The lamp assembly of claim 8, further comprising a torsion spring returning the second shield to an initial position when an external force is removed from the second shield.

10. The lamp assembly of claim 7, wherein:
the first shield comprises a slider and a female screw that is joined with the lead screw; and
the fixed shield cover comprises a slot guiding the slider to linearly move and a circular ring to which an end of the lead screw joined with the female screw is inserted.

11. The lamp assembly of claim 10, wherein:
the first shield further comprises a through hole vertically penetrating the first shield; and
the second shield is inserted through the through hole.

12. The lamp assembly of claim 6, wherein the beam patterns comprise two or more of class C, class E, class V, and a high lamp pattern.

13. The lamp assembly of claim 12, wherein:
the C class is formed by the cut off pattern of the first shield;
the E class is formed by a combination of the cut off pattern of the first shield and the cut off pattern of the second shield;
the V classis is formed by an upper line of the cut off pattern of the first shield; and
the high lamp pattern is formed by the notch of the fixed shield.

14. A lamp shield driving apparatus comprising:
a first shield having a predetermined cut off pattern;
a second shield overlapping with the first shield, and having a different cut off pattern from that of the first shield; and
a driving unit linearly moving either the first shield or the second shield,
wherein two or more beam patterns are formed in accordance with the movement of any one of the shields while the first shield overlaps with the second shield.
